(19) United States
(12) Patent Application Publication
(10) Pub. No.: US 2012/0158691 A1
(43) Pub. Date: Jun. 21, 2012

(54) APPARATUS AND METHOD OF SEARCHING HS CODES USING ONTOLOGY

(75) Inventors: Kyung-Ah YANG, Daejeon (KR); Moonyoung CHUNG, Daejeon (KR); Kyong-I KU, Daejeon (KR)

(73) Assignee: Electronics and Telecommunications Research Institute, Daejeon (KR)

(21) Appl. No.: 13/278,372

(22) Filed: Oct. 21, 2011

(30) Foreign Application Priority Data
Dec. 15, 2010 (KR) 10-2010-0128475

(51) Int. Cl. G06F 17/30

(52) U.S. Cl. 707/706; 707/758; 707/E17.014

(57) ABSTRACT

An apparatus of searching a HS code for a product includes a database (DB) for storing HS codes with respect to various products, an ontology editor for converting the HS codes into an ontology, and a search unit for searching the DB for a HS code corresponding to a search word for the product by using the ontology of the HS codes. The search unit is configured to create a HS code ontology and a domain ontology with respect to the product having the search word, extract a feature vector with respect to an individual class of the HS code ontology, extend the extracted feature vector by using the domain ontology, and search for the HS code of the product by using the extended feature vector.

### CROSS-REFERENCE TO RELATED APPLICATION(S)

The present invention claims priority of Korean Patent Application No. 10-2010-0128475, filed on Dec. 15, 2010, which is incorporated herein by reference.

### FIELD OF THE INVENTION

The present invention relates to a technique of searching a harmonized commodity description and coding system (HS) code used in a service for determining the origin source of products, and more particularly, to an apparatus and method of searching HS codes of products based on an ontology.

### BACKGROUND OF THE INVENTION

Recently, FTA has come into effect with fourteen countries as a result of the promotion of FTA-signed multi-lateralization policies in Korea, and it is anticipated to extend to about 50 countries inclusive of the USA and EU that are a gigantic economic block since 2010 and in the future. FTA may boost export growth, manufacturing, and an employment promotion, playing the motive power for the growth of Korea.

In order to obtain tariff benefits with respect to exports in relation to the effectuation of FTA, a harmonized commodity description and coding system (HS) code is granted to export articles. The term ‘HS code’ refers to a product classification code granted to internationally traded goods based on a HS convention. For a product classification, Korea uses 10 digits with HS of Korea (HSK) the USA uses 10 digits, China uses 8 digits, Japan uses 9 digits. Among digits, 6 digits are commonly used internationally. To have an FTA tax favor, exporters and importers or the authorities concerned perform a product classification in order to recognize the qualities and state of corresponding articles to check which of the numbers of the article numbers prescribed in the customs act it corresponds, in which the product classification uses a HS code. In spite of identical export articles, the rule of origin with respect to HS codes may be different for each FTA. The FTA determination criterion is settled by HS codes, so a corresponding article must be precisely classified to check the origin source thereof.

Currently, in order to check the HS codes of exported or imported goods for determining the origin source, a relevant rule book is looked for, or an expert, e.g., a registered customs specialist, is consulted. In addition, a profession organization such as Customs Service provides web site for a HS search to allow users to directly search for the HS code.

However, an available HS code searching system provides only a simple keyword searching-centered service, causing a problem in which concepts related to HS codes to be searched cannot be considered overall.

### SUMMARY OF THE INVENTION

In view of the above, therefore, the present invention provides an apparatus and method of HS code searching on a basis of ontology capable of easily and intelligently searching a HS code appropriate for exported articles by using search words sufficiently expressing the articles.

In accordance with an aspect of the present invention, there is provided an apparatus of searching a harmonized commodity description and coding system (HS) code for a product, the apparatus including:

a database (DB) for storing HS codes with respect to various products;

an ontology editor for converting the HS codes into an ontology; and

a search unit for searching the DB for a HS code corresponding to a search word for the product by using the ontology of the HS codes.

Preferably, the search unit is configured to create a HS code ontology and a domain ontology with respect to the product having the search word, extract a feature vector with respect to an individual class of the HS code ontology, extend the extracted feature vector by using the domain ontology, and search for the HS code of the product by using the extended feature vector.

Preferably, the search unit is further configured to infer terms the domain ontology related to the search word, and extend the extracted feature vector with the reasoned relevant terms.

Preferably, one HS code is converted into one ontology class.

Preferably, wherein the search unit includes:

a search engine for executing searching of a HS code with respect to the product having the search word;

an ontology management unit for converting a classification system of the HS codes into a hierarchical ontology by interworking with the ontology editor;

a feature vector processing unit for performing a morpheme analysis on attribute given to each class of the HS code ontology; and

a synonym/relevant-word processing unit for creating additional feature vectors by comparing individual keywords of the feature vectors of each HS code in the HS code ontology with names of classes of the domain ontology.

Preferably, the DB unit includes:

a HS code DB for storing the HS codes;

a HS code ontology DB for storing the HS code ontology;

a feature vector DB storing feature vectors extracted from descriptions of the HS codes; and

a domain ontology DB for storing synonyms and relevant words with respect to respective terms in the HS code ontology.

Preferably, ontology management unit is configured to extract the ontology terms related to the search word through reasoning from the domain ontology DB and return the extracted terms to the search engine.

Preferably, the feature vector processing unit is configured to store a keyword set obtained through the morpheme analysis, as feature vectors, in the feature vector DB.

Preferably, the DB unit further includes an index DB for storing index information to index the HS codes with ontology terms.

Preferably, the product is an exported or imported article.

In accordance with another aspect of the present invention, there is provided a method of searching for a harmonized commodity description and coding system (HS) code of a product, the method including:

receiving a search word for the product;

creating a HS code ontology and a domain ontology with respect to the product;

extracting a feature vector of the product by using the HS code ontology and the domain ontology;

extending the search word through reasoning by comparing the search word with ontology terms; and

searching for the HS code of the product on the feature vector.

Preferably, said extracting a feature vector includes:

extracting a feature vector with respect to individual classes of the HS code ontology; and

extending the feature vector by using the domain ontology.

Preferably, the feature vector is a keyword set with respect to the HS code which is obtained by performing a morpheme analysis on the names and descriptions which are attribute information given to the classes.

Preferably, one HS code is converted into one ontology class.

### BRIEF DESCRIPTION OF THE DRAWINGS

The above and other objects and features of the present invention will become apparent from the following description of embodiments, given in conjunction with the accompanying drawings, in which:

FIG. 1 shows a block diagram of an apparatus of HS code searching based on ontology in accordance with an embodiment of the present invention;

FIG. 2 is a flowchart illustrating a process of searching a HS code by using ontology in accordance with an embodiment of the present invention;

FIG. 3 is a view showing an example of creating HS code ontology in accordance with an embodiment of the present invention; and

FIG. 4 is a view showing extension of feature vector between HS code ontology and domain ontology in accordance with an embodiment of the present invention.

### DETAILED DESCRIPTION OF THE EMBODIMENTS

Hereinafter, embodiments of the present invention will be described in detail with reference to the accompanying drawings.

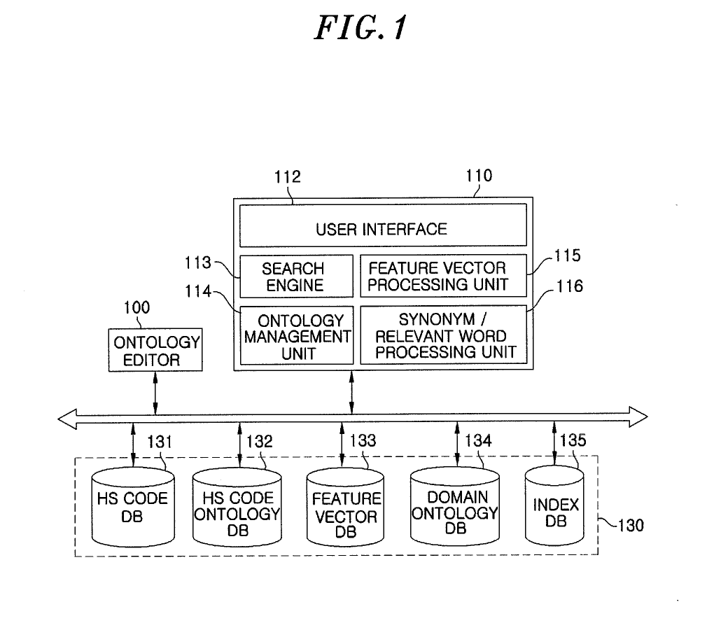

FIG. 1 shows a block diagram of an apparatus of HS code searching based on ontology in accordance with an embodiment of the present invention.

Referring to FIG. 1, the apparatus of HS code searching of the present invention includes an ontology editor 100, a searching unit 110, an Internet server 120, and a database (DB) module 130.

The DB module 130 stores HS codes, and the ontology editor 100 converts the HS codes stored in the DB 130 into ontology. The searching unit 110 searches a HS code of an exported article through a search word.

The DB module 130 includes a HS code DB 131, a HS code ontology DB 132, a domain ontology DB 134, a feature vector DB 133, and an index DB 135. The HS code DB 131 stores HS codes to be created a HS code ontology. The HS code ontology DB 132 stores the created HS code ontology. The domain ontology DB 134 stores synonyms and relevant words with respect to respective terms of the HS code ontology. The feature vector DB 133 stores feature vectors, which are a keyword sets extracted from description of the HS codes. The index DB 135 stores information for indexing a HS code by an ontology term.

The searching unit 110 includes a user interface (UI) 112, a search engine 113, an ontology management unit 114, a feature vector processing unit 115, and a synonym/relevant-word processing unit 116.The UI 112 is an interface allowing a user in charge of an origin source management to search a HS code appropriate for a particular product. The search engine 113 executes searching the DB 130 based on a search word input by the user through the UI 112 and returns search results.

The ontology management unit 114, which interworks with the ontology editor 100, converts a classification system of HS codes stored in the HS code DB 131 into a hierarchical ontology. For example, in case of Korea, an ontology is created based on upper and lower relationships of HS codes declared in harmonized system of Korea (HSK) discriminating exported and imported articles into 11,261. In this case, one HS code is converted into one class of a HS code ontology, and information regarding the name and description of the HS code is converted into the attribute of the name and description of the class of the HS code ontology. The ontology so converted is stored in the HS code ontology DB 132. An ontology expert or a user may perform a supplementary operation such as correcting the HS code ontology stored in the HS code ontology DB 132 or adding an ontology term through the ontology editor 100.

A search word is entered through the UI 112 for searching a HS code and is then transferred through the search engine 113 to the ontology management unit 114. The ontology management unit 114 infers to extract ontology terms related to the search word from the domain ontology DB 134, extends relevant words to the ontology term, and returns the same to the search engine 113. The feature vector processing unit 115 performs a morpheme analysis on the name and description, which are the attribute information given to each class of the HS code ontology, to extract keywords capable of representing the respective HS codes. By performing morpheme analysis, as set forth above, a keyword set, i.e., feature vectors, with respect to HS codes, is extracted and the extracted feature vectors are then stored in the feature vector DB 133.

The synonym/relevant-word processing unit 116 compares individual keywords of feature vectors of each HS code in the HS code ontology with the names of the class of the domain ontology to retrieve synonym and relevant words from the domain ontology. The retrieved synonym and relevant words are employed to extend the feature vectors.

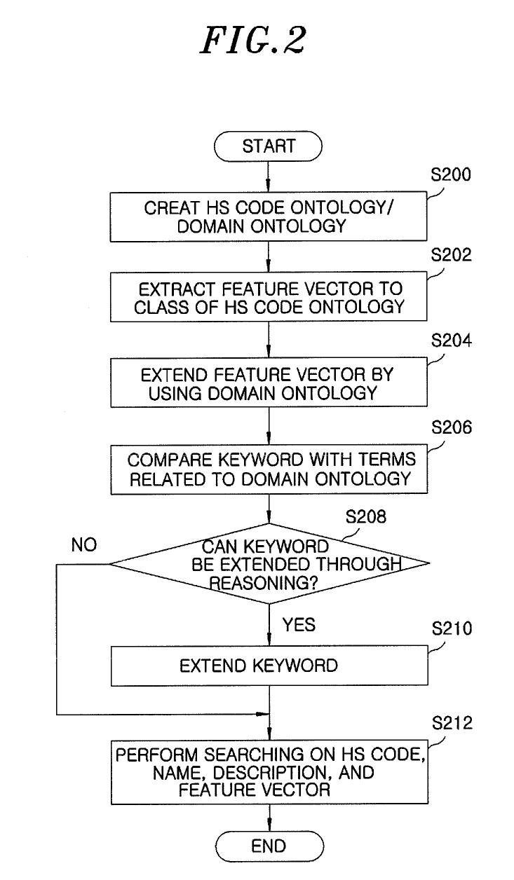

FIG. 2 is a flowchart illustrating a method of searching a HS code by using ontology in accordance with an embodiment of the present invention.

In step S200, when a search word of a product desired to be searched is input through the UI 112, the ontology management unit 114 creates a HS code ontology and a domain ontology with respect to the search word by interworking with the ontology editor 100.

The HS codes exist in the form of a table in the HS code DB 131, and the ontology editor 100 imports the HS code table from the HS code DB 131 and discriminates the HS codes based on a large classification and small classification format of the HS codes to create a hierarchical HS code ontology.

Currently, the HS codes provide a classification criterion with respect to a total of 10 different domains (or categories). Thus, an expert for the respective domains draws up a domain ontology by using the ontology editor 100 with respect to the corresponding domain. Respective classes and instances belonging to the domain ontology have synonyms/equivalents and are associated with relevant classes via various meaning relationship specified in the domain ontology.

The ontology management unit 114 converts the classification system of the HS codes stored in the HS code DB 131 into a hierarchical ontology by interworking with the ontology editor 100.

Next, in step S202, feature vectors for an individual class of the HS code ontology are extracted by the feature vector processing unit 115. More specifically, the class of the HS code ontology has a description of a HS code representative of an attribute thereof. Thus, in order to extract a keyword which may represent a HS code among the HS codes, a morpheme analysis is performed on the name and description which are attribute information given to each class of the HS code ontology. A keyword set with respect to the HS codes is extracted based on the morpheme analysis.

The keyword set becomes feature vectors exhibiting the feature of the class, and the feature vectors extracted for respective classes in this manner are stored in the feature vector DB 133.

Subsequently, in step S204, the synonym/relevant word processing unit 116 compares the individual keywords of the feature vector of each HS code in the HS code ontology with the names of the class of the domain ontology, and retrieves a synonym and relevant word prescribed in the domain ontology to extend the feature vector.

More particularly, after the extraction of the feature vectors for the HS ontology, the synonym/relevant word processing unit 116 compares a class and an instance of the HS ontology and the class and instance of the domain ontology to find out matched ones therebetween. Here, when a matched class and instance are found, the synonym/relevant word processing unit 116 adds synonyms and equivalents to the class and instance of the domain ontology to the feature vector of the HS code ontology.

The HS code ontology and the domain ontology drawn up as set forth are used for the HS search service as described below.

When the user inputs a search word to be searched through the UI 112, first, the search word is extended by using the domain ontology in step S206. The extended search word is used to search a HS code of the product.

When there is no extended search term while using the domain ontology, a comparison is made whether the search word exists in the name and attribute of a class and an instance of the HS code ontology and the feature vectors. Subsequently, a HS code having the same term as the search word is extracted to extend the search word.

Thereafter, in step S208, the ontology management unit 114 determines whether or not the keyword can be extended through reasoning. When the keyword can be extended through reasoning, in step S210, the ontology management unit 114 extracts ontology terms related to the search word from the domain ontology DB 134 to extend the keyword with respect to the feature vector through reasoning. Consequently, in step S212, the search engine 113 executes searching on HS codes, the name, description, and feature vector.

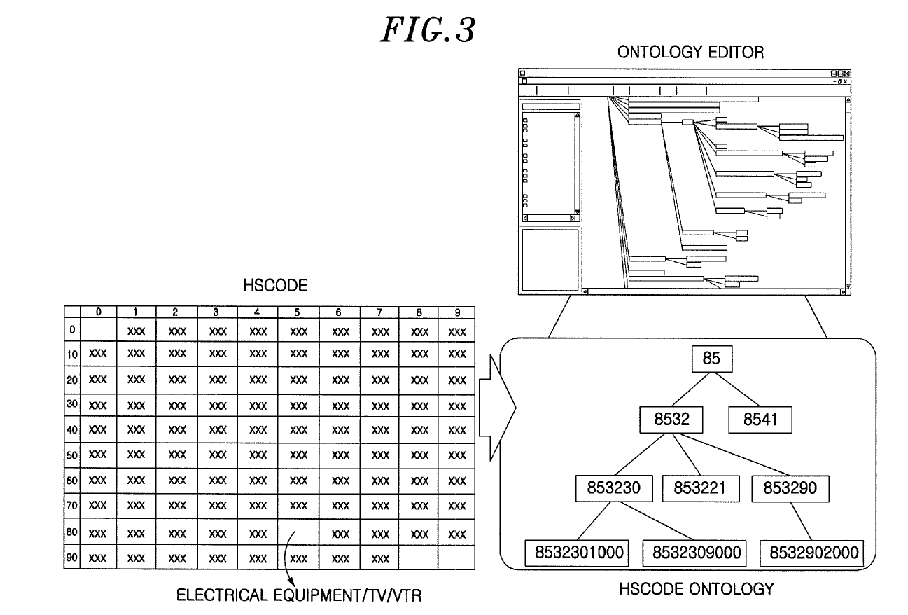

FIG. 3 is a view showing an example of creating a HS code ontology in accordance with an embodiment of the present invention.

The ontology used for the HS code searching apparatus is largely composed of a HS code ontology and a domain ontology created by a domain expert.

The HS code ontology may be automatically created by importing the already created HS code DB 131 through the use of the ontology editor 100 to automatically create the HS code ontology, or may be directly created a trade-related expert such as a registered customs specialist through the use of the ontology editor 100. With reference to FIG. 3, two-digit HS code 85 as the uppermost number of ‘electrical equipment/TV/VTR’ classification may have one or more 4-digit lower HS codes, for example 8532 and 8541 (not shown). Among them, 8532 is an item number corresponding to an ‘electric condenser’ and has hierarchically lower item numbers, for example, 853230 and 853221. The set of 11,261 HS codes with upper and lower relationships can be expressed by a vertically hierarchical ontology.

One HS code is mapped to one class, and the name and description information regarding the HS code are separately stored as the name and description attribute of an ontology class. These attribute information will be subject to a morpheme analysis when a keyword for one HS code is extracted.

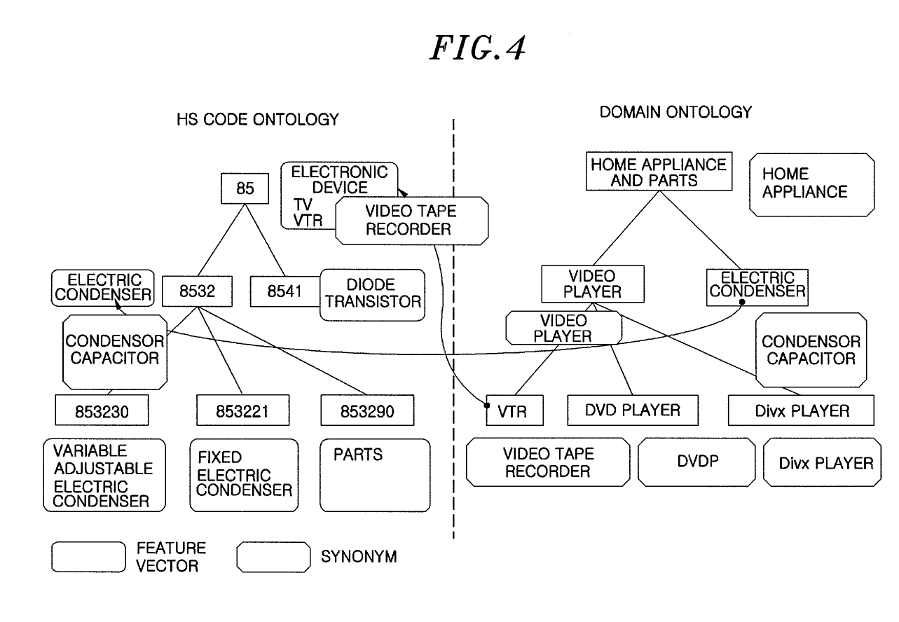

FIG. 4 is a view showing extension of feature vector between HS ontology and domain ontology in accordance with an embodiment of the present invention.

A domain ontology is a standardized ontology created by a domain expert in a particular field. The domain ontology contains expert knowledge regarding various fields handled in the HS codes, and has a vertical relationship with an upper class and a lower class and a horizontal relationship associated with other classes having similar properties. A feature vector for a HS code may be created by using the HS code ontology and the domain ontology, which will be explained below.

First, the uppermost class of the HS code ontology is accessed to perform a morpheme analysis on the ‘name’ and ‘description’ attributes of the uppermost class, and keywords which may represent a HS code are extracted by using a keyword extraction algorithm. The set of extracted keywords becomes a feature vector exhibiting the feature of the class. When the extraction of the feature vector for the uppermost class is finished, extracting a feature vector is performed on lower classes by using a search algorithm.

After the feature vector extraction is performed on every class in the HS code ontology, the classes of the HS code ontology and those of the domain ontology are compared to extend synonym and relevant words of the domain ontology to the feature vector.

Classes commonly existing in the HS code ontology and the domain ontology are inspected. If the common class in the domain ontology has synonym and equivalents, they are added to the common class to and utilized as synonyms and equivalents of the common class in the HS code ontology. The synonyms and equivalents added to the common class of the HS code ontology serves to complement the already created feature vector. As such, the comparison between the HS code ontology and the domain ontology enables the classes in the HS code ontology to have more plentiful feature vectors.

For example, it is assumed that there are a HS ontology and a domain ontology as shown in FIG. 4. Then, the HS code ontology starting from the number 85, which is a HS code of a product referred to as an ‘electric and home appliance’, may be compared with a ‘home appliance and component’ ontology in the domain ontology in order to extend the feature vector.

Also, a class 8532 in the HS code ontology in FIG. 4 has an ‘electric condenser’ as name attribute, and this class is compared with all the classes in the domain ontology. In this case, ‘condenser’ and ‘capacitor’, which are the synonym and relevant words of a class ‘electric condenser’ having the identical name in the domain ontology, may be added to the feature vector of the class 8532 in the HS code ontology.

The following two types of extension searching may be performed by using the HS code ontology and the domain ontology. The first method is to utilize a feature vector, which is a keyword set of the HS code.

On the assumption that the user inputs a simple search word ‘condenser’ on a universal HS code searching site without employing feature vectors, a item classification 8232 is not searched. In contrast, the novel apparatus has an extended expert knowledge based on ontology. Therefore, when the search word ‘condenser’ is input, since the class 8532 contains the feature vector inclusive of the search word, the product number 8532 can be looked for as search results.

The searching apparatus in accordance with the present invention can obtain a high accuracy and a high reproducibility by using the feature vectors representing the HS codes as well as performing searching on the name and description fields of the item classification. The second method is to extend a search word. When the user inputs only a simple search word, the search word can be extended by using the vertical relationship and the connection relationship of the domain ontology. When the search work exists in the ontology, an upper word, a lower word, and synonyms of the ontology term corresponding to the search word are present to the user through the UI, and the user may then select desired terms to extend the search word. When the user inputs only one search word ‘condenser’ in the search window arranged in the apparatus of the present invention, relevant words {capacitor, condenser}; upper words {home appliance and component, appliance parts, home application}; the upper words {video recording/reproducing apparatus}; and the lower word {video player}, are presented to the user. The user may select one or more words from the candidate words as presented, and utilize them to supplement the search word.

In accordance with the present invention, in search for the HS code using ontology, the limited knowledge of the user can be extended by using the HS codes and the ontology, which is an expert knowledge, regarding domains of various fields, whereby the HS codes appropriate for an article can be easily searched.

Also, a HS code regarding one exported or imported product can be easily searched by interworking with a Web-based application which essentially uses other HS codes as well as an origin source management system.

While the invention has been shown and described with respect to the particular embodiments, it will be understood by those skilled in the art that various changes and modification may be made without departing from the scope of the present invention as defined in the following claims.

What is claimed is:

1. An apparatus of searching a harmonized commodity description and coding system (HS) code for a product, the apparatus comprising:
a database (DB) for storing HS codes with respect to various products;
an ontology editor for converting the HS codes into an ontology; and
a search unit for searching the DB for a HS code corresponding to a search word for the product by using the ontology of the HS codes.

2. The apparatus of claim 1, wherein the search unit is configured to create a HS code ontology and a domain ontology with respect to the product having the search word, extract a feature vector with respect to an individual class of the HS code ontology, extend the extracted feature vector by using the domain ontology, and search for the HS code of the product by using the extended feature vector.

3. The apparatus of claim 1, wherein the search unit is configured to infer terms the domain ontology related to the search word, and extend the extracted feature vector with the reasoned relevant terms.

4. The apparatus of claim 1, wherein one HS code is converted into one ontology class.

5. The apparatus of claim 1, wherein the search unit includes:
a search engine for executing searching of a HS code with respect to the product having the search word;
an ontology management unit for converting a classification system of the HS codes into a hierarchical ontology by interworking with the ontology editor;
a feature vector processing unit for performing a morpheme analysis on attribute given to each class of the HS code ontology; and
a synonym/relevant-word processing unit for creating additional feature vectors by comparing individual keywords of the feature vectors of each HS code in the HS code ontology with names of classes of the domain ontology.

6. The apparatus of claim 5, wherein the DB unit includes:
a HS code DB for storing the HS codes;
a HS code ontology DB for storing the HS code ontology;
a feature vector DB storing feature vectors extracted from descriptions of the HS codes; and
a domain ontology DB for storing synonyms and relevant words with respect to respective terms in the HS code ontology.

7. The apparatus of claim 6, wherein the ontology management unit is configured to extract the ontology terms related to the search word through reasoning from the domain ontology DB and return the extracted terms to the search engine.

8. The apparatus of claim 5, wherein the feature vector processing unit is configured to store a keyword set obtained through the morpheme analysis, as a feature vector value, in the feature vector DB.

9. The apparatus of claim 6, wherein the DB unit further includes an index DB for storing index information to index the HS codes with ontology terms.

10. The apparatus of claim 1, wherein the product is an exported or imported article.

11. A method of searching for a harmonized commodity description and coding system (HS) code of a product, the method comprising:
receiving a search word for the product;
creating a HS code ontology and a domain ontology with respect to the product;
extracting a feature vector of the product by using the HS code ontology and the domain ontology;
extending the search word through reasoning by comparing the search word with ontology terms; and
searching for the HS code of the product on the feature vector.

12. The method of claim 11, wherein said extracting a feature vector includes:
extracting a feature vector with respect to individual classes of the HS code ontology; and
extending the feature vector by using the domain ontology.

13. The method of claim 12, wherein the feature vector is a keyword set with respect to the HS code which is obtained by performing a morpheme analysis on the names and descriptions which are attribute information given to the classes.

14. The method of claim 12, wherein one HS code is converted into one ontology class.
